(19) United States
(12) Patent Application Publication
(10) Pub. No.: US 2025/0371416 A1
(43) Pub. Date: Dec. 4, 2025

(54) MULTI-MODEL POLLING FOR AUTOMATED TECHNICAL SUPPORT

(71) Applicant: Insight Direct USA, Inc., Chandler, AZ (US)

(72) Inventors: Scott Joynt, Delaware, OH (US); Jason Rader, Jacksonville, FL (US); David McCurdy, Centennial, CO (US)

(21) Appl. No.: 18/911,913

(22) Filed: Oct. 10, 2024

Related U.S. Application Data
(60) Provisional application No. 63/655,952, filed on Jun. 4, 2024.

(51) Int. Cl. G06N 20/00; G06F 40/40

(52) U.S. Cl. CPC G06N 20/00; G06F 40/40

(57) ABSTRACT

A method of automated technical support includes receiving a natural-language text prompt provided by a user and including at least one technical query, providing a first system prompt to a primary general-purpose machine-learning language model, and providing the natural-language text prompt to the primary general-purpose machine-learning language model and each of a plurality of specialized machine-learning language models after providing the first system prompt. The method further includes generating a plurality of natural-language text outputs by the plurality of specialized machine-learning language models and the primary general-purpose machine-learning language model, generating an aggregated prompt by combining the plurality of natural-language text outputs, providing a second system prompt to the primary general-purpose machine-learning language model, providing the aggregated prompt to the primary general-purpose machine-learning language model after providing the second system prompt, and generating an orchestrated natural-language text output based on the aggregated prompt by the primary general-purpose machine-learning language model.

### CROSS-REFERENCE TO RELATED APPLICATION

This application is a nonprovisional application claiming the benefit of U.S. provisional Ser. No. 63/655,952, filed on Jun. 4, 2024, entitled “MULTI-MODEL POLLING FOR AUTOMATED TECHNICAL SUPPORT” by S. Joynt, J. Rader, and D. McCurdy.

### FIELD OF THE INVENTION

The present disclosure relates to automated technical support and, more particularly, to systems and methods for performing automated technical support using computer-implemented machine-learning language models.

### BACKGROUND

Generative artificial intelligence (AI) language models, such as large language models and/or transformer models, are capable of dynamically generating content based on user prompts. Some language models are capable of generating human-like text and can be incorporated into text chat programs in order to mimic the experience of interacting with a human in a text chat.

### SUMMARY

An example of a method of automated technical support includes receiving a natural-language text prompt provided by a user and including at least one technical query, providing a first system prompt to a primary general-purpose machine-learning language model, and providing the natural-language text prompt to the primary general-purpose machine-learning language model and each of a plurality of specialized machine-learning language models after providing the first system prompt. The method further includes generating, by the plurality of specialized machine-learning language models and the primary general-purpose machine-learning language model, a plurality of natural-language text outputs, where one natural-language text output of the plurality of natural-language text outputs is from the primary general-purpose machine-learning language model and a remainder of the plurality of natural-language text outputs are from the plurality of specialized machine-learning language models. The method yet further generating includes an aggregated prompt by combining the plurality of natural-language text outputs, providing a second system prompt to the primary general-purpose machine-learning language model, providing the aggregated prompt to the primary general-purpose machine-learning language model after providing the second system prompt, and generating an orchestrated natural-language text output based on the aggregated prompt by the primary general-purpose machine-learning language model. The first system prompt instructs the primary general-purpose language model to generate an answer to user prompts, the second system prompt instructs the primary general-purpose machine-learning language model to generate an answer to user prompts based on machine-learning language model outputs, and the orchestrated natural-language text output is responsive to the at least one technical query.

An example of a system for automated technical support includes a user device electronically-connected to a network and a server electronically-connected to the network and including a processor and at least one memory. The at least one memory is encoded with instructions that, when executed, cause the processor to receive a natural-language text prompt from a user device. The natural-language text prompt is provided by a user and includes at least one technical query. The instructions, when executed, further cause the processor to provide a first system prompt to a primary general-purpose machine-learning language model, the natural-language text prompt to the primary general-purpose machine-learning language model and each of a plurality of specialized machine-learning language models after the first system prompt, and generate, using the plurality of specialized machine-learning language models and the primary general-purpose machine-learning language model, a plurality of natural-language text outputs, where one natural-language text output of the plurality of natural-language text outputs is from the primary general-purpose machine-learning language model and a remainder of the plurality of natural-language text outputs is from the plurality of specialized machine-learning language models. The instructions, when executed, further cause the processor to generate an aggregated prompt by combining the plurality of natural-language text outputs, provide a second system prompt to the primary general-purpose machine-learning language model, provide the aggregated prompt to the primary general-purpose machine-learning language model after the second system prompt, and generate an orchestrated natural-language text output based on the aggregated prompt using the primary general-purpose machine-learning language model. The first system prompt instructs the primary general-purpose language model to generate an answer to user prompts, the second system prompt instructs the primary general-purpose machine-learning language model to generate an answer to user prompts based on machine-learning language model outputs, and the orchestrated natural-language text output is responsive to the at least one technical query.

The present summary is provided only by way of example, and not limitation. Other aspects of the present disclosure will be appreciated in view of the entirety of the present disclosure, including the entire text, claims, and accompanying figures.

### BRIEF DESCRIPTION OF THE DRAWINGS

FIG. 1 is a schematic diagram of an example of a system for automated technical support using multi-model polling.

FIG. 2 is a flow diagram of an example of a method of performing automated technical support using multi-model polling performable by the system of FIG. 1.

FIG. 3 is a flow diagram of another example of a method of performing automated technical support using multi-model polling performable by the system of FIG. 1.

FIG. 4 is a flow diagram of an example of a method of fine-tuning or training a general-purpose computer-implemented machine-learning language model to generate a specialized computer-implemented machine-learning language model for use by the system of FIG. 1 or with the methods of FIGS. 2-3.

While the above-identified figures set forth one or more examples of the present disclosure, other examples are also contemplated, as noted in the discussion. In all cases, this disclosure presents the invention by way of representation and not limitation. It should be understood that numerous other modifications and examples can be devised by those skilled in the art, which fall within the scope and spirit of the principles of the invention. The figures may not be drawn to scale, and applications and examples of the present invention may include features and components not specifically shown in the drawings.

### DETAILED DESCRIPTION

The present disclosure relates to systems and methods for automated technical support performed using machine-learning language models. More specifically, the present disclosure relates to systems and methods for generating natural-language responsive to user technical questions using a multi-model polling approach. As will be described in more detail subsequently, the multi-model polling approach detailed herein generates a set of outputs to a user prompt using multiple specialized machine-learning language models. The outputs from the specialized models are then combined into a single, aggregated prompt that is provided to a general-purpose machine-learning language model to generate the final natural-language output that is provided to the user in response to the user's technical query contained in the original prompt. The specialized models are specialized for different technical problems, different technical product vendors, different technical products, etc. and the language associations encoded in the general-purpose machine-learning language model are leveraged to select output information from the set of outputs that is relevant to the user's technical query. Advantageously, the multi-model polling approach described herein enables improved accuracy of automated technical support responses and reduces the likelihood that a response generated using a machine-learning language models contain hallucinations or fabrications. Further, the multi-model polling approach outlined herein provides improved response accuracy (i.e., to user technical problems) as compared to context injection approaches reliant on vector databases, such as retrieval augmented generation approaches.

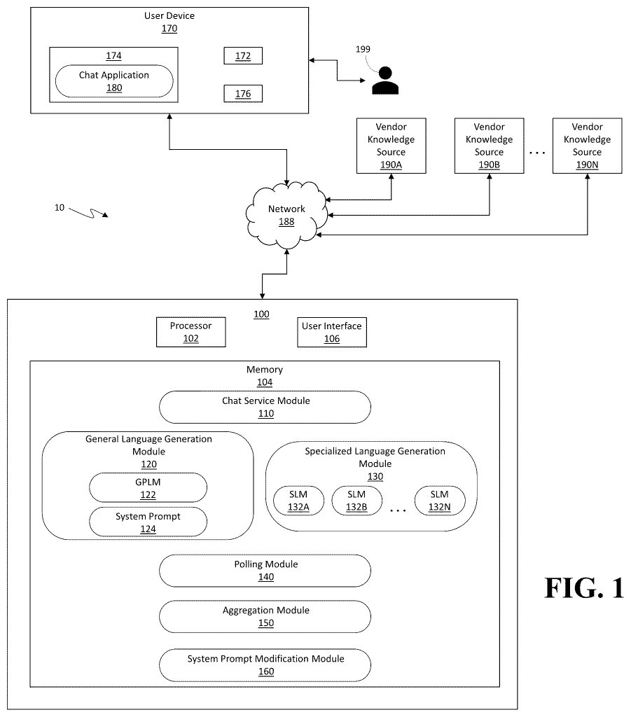

FIG. 1 is a schematic depiction of technical support system 10, which is a system for generating natural-language responses to user-generated prompts that include technical questions or queries using a multi-model polling approach. System 10 includes server 100, user device 170, network 188, and vendor knowledge sources 190A-N. Server 100 includes processor 102, memory 104, and user interface 106. Memory 104 stores chat service module 110, general language generation module 120, specialized language generation module 130, polling module 140, aggregation module 150, and system prompt modification module 160. General language generation module 120 includes general-purpose language model (GPLM) 122 and system prompt 124, and specialized language generation module 130 includes specialized language models (SLMs) 132A-132N. User device 170 includes processor 172, memory 174, and user interface 176. Memory 174 includes chat application 180. FIG. 1 also depicts user 199.

Server 100 is a network-connected device that is connected to network 188 and is configured to operate a technical support chat service accessible to users via network. In particular, server 100 is configured to perform automated technical support of user technical issues and is able to generate natural-language responsive to user technical issues. As used herein, “automated technical support” or “automated support” refers to technical support provided to a user using one or more automated natural-language messages generated by server 100 or another suitable computing device. Conversely, as used herein, “human-mediated technical support” or “human-mediated support” refers to technical support provided to a user by a human technical support technician. Server 100 includes or more hardware elements, devices, etc. for facilitating electronic communication with network 188 via one or more wired and/or wireless connections. Server 100 is able to communicate with user device 170 via network 188. Although server 100 is generally referred to herein as a server, server 100 can be any suitable network-connectable computing device for performing the functions of server 100 detailed herein.

As will be explained in more detail subsequently, server 100 polls SLMs 132A-N during language generation to generate a set of specialized outputs and, in some examples, also polls GPLM 122. Server 100 then aggregates the outputs of SLMs 132A-N and, optionally, GPLM 122. Server 100 provides an updated system prompt to GPLM 122 instructing GPLM 122 to act as an orchestrator and to provide an answer to the user's query based on outputs from other machine-learning language models and, subsequently, provides the aggregated language output (i.e., from SLMs 132A-N and optionally also from GPLM 122) as an input to GPLM 122. Server 100 is then able to provide the orchestrated output from GPLM 122 to the user who submitted the technical query as an answer to the technical question.

Processor 102 can execute software, applications, and/or programs stored on memory 104. Examples of processor 102 can include one or more of a processor, a microprocessor, a controller, a digital signal processor (DSP), an application specific integrated circuit (ASIC), a field-programmable gate array (FPGA), or other equivalent discrete or integrated logic circuitry. Processor 102 can be entirely or partially mounted on one or more circuit boards.

Memory 104 is configured to store information and, in some examples, can be described as a computer-readable storage medium. Memory 104, in some examples, is described as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, memory 104 is a temporary memory. As used herein, a temporary memory refers to a memory having a primary purpose that is not long-term storage. Memory 104, in some examples, is described as volatile memory. As used herein, a volatile memory refers to a memory that that the memory does not maintain stored contents when power to the memory 104 is turned off. Examples of volatile memories can include random access memories (RAM), dynamic random access memories (DRAM), static random access memories (SRAM), and other forms of volatile memories. In some examples, the memory is used to store program instructions for execution by the processor. Memory 104, in one example, is used by software or applications running on server 100 (e.g., by a computer-implemented machine-learning model) to temporarily store information during program execution.

Memory 104, in some examples, also includes one or more computer-readable storage media. The storage media can be configured to store larger amounts of information than volatile memory and, further, can be configured for long-term storage of information. In some examples, memory 104 includes non-volatile storage elements. Examples of such non-volatile storage elements can include, for example, magnetic hard discs, optical discs, floppy discs, flash memories, or forms of electrically programmable memories (EPROM) or electrically erasable and programmable (EEPROM) memories.

User interface 106 is an input and/or output device and/or software interface, and enables an operator to control operation of and/or interact with software elements of server 100. For example, user interface 106 can be configured to receive inputs from an operator and/or provide outputs. User interface 106 can include one or more of a sound card, a video graphics card, a speaker, a display device (such as a liquid crystal display (LCD), a light emitting diode (LED) display, an organic light emitting diode (OLED) display, etc.), a touchscreen, a keyboard, a mouse, a joystick, or other type of device for facilitating input and/or output of information in a form understandable to users and/or machines.

In some examples, server 100 can operate an application programming interface (API) (e.g., as a software component of user interface or as another software component of server 100) for facilitating communication between server 100 and other devices connected to network 188 as well as for allowing devices connected to network 188 to access functionality of server 100. A device connected to network 188, such as 170, can send a request to an API operated by server 100 to, for example, generate language in response to user technical queries.

User device 170 is an electronic device that a user (e.g., user 199) can use to access network 188 and functionality of server 100 (i.e., via network 188). User device 170 includes processor 172, memory 174, and user interface 176, which are substantially similar to processor 102, memory 104, and user interface 106, respectively, and the discussion herein of processor 102, memory 104, and user interface 106 is applicable to processor 172, memory 174, and user interface 176, respectively. User device 170 includes networking capability for sending and receiving data transmissions via network 188 and can be, for example, a personal computer or any other suitable electronic device for performing the functions of user device 170 detailed herein. Memory 174 stores software elements of chat application 180 and preference management application 180, which will be discussed in more detail subsequently and particularly with respect to the function of chat service module 110 of server 100.

Network 188 is a network suitable for connecting and facilitating network communication between server 100, user device 170, and vendor knowledge sources 190A-N. Network 188 can include any suitable combination of local network and wide area network (WAN) elements or components to connect server 100, user device 170, and vendor knowledge sources 190A-N. In some examples, the wide area network can be or include the Internet. For example, server 100 can be connected to vendor knowledge sources 190A-N via a local network and server 100 can be connected to user device 170 via a WAN. As a further example, server 100 can be connected to all of user device 170 and vendor knowledge sources 190A-N via a WAN (e.g., the Internet). In yet further examples, server 100 can be connected to some of vendor knowledge sources 190A-N via a WAN and others of vendor knowledge sources 190A-N via a local network.

Vendor knowledge sources 190A-N are electronic devices connected to network 188 and function as knowledge sources that contain technical information for technical products offered by a particular vendor. Each vendor knowledge sources 190A-N includes technical information for a single vendor and, in at least some examples, each vendor knowledge source 190A-N stores technical information for a different or unique vendor. Vendor knowledge sources 190A-N can, for example, store product documentation, troubleshooting strategies, and/or any other suitable kind of technical information for a technical product. Each of vendor knowledge sources 190A-N includes can include one or more electronic databases and/or electronic knowledge bases accessible by server 100 and/or another suitable device via network 188. Each of vendor knowledge sources 190A-N includes a processor and at least one memory that are substantially similar to processor 102 and memory 104, respectively. Each of vendor knowledge sources 190A-N can also include a user interface that is substantially similar to user interface 106 of server 100. Vendor knowledge sources 190A-N retrievably store information and are searchable (e.g., as a knowledge base) and/or queryable (e.g., as a database) to allow server 100 and/or other devices connected to network 188 to retrieve technical information stored to vendor knowledge sources 190A-N. Vendor knowledge sources 190A-N that are accessible as knowledge bases or a similar knowledge repository can include one or more search applications, modules, etc. for retrieve stored technical information as well as one or more databases for storing and organizing data describing vendor-specific technical information. Where a knowledge source 190A-N is or includes a database, the database can be any suitable type of database and can include a database management system (DBMS) for organizing and retrieving stored technical information.

Chat service module 110 is a software module of server 100 and includes one or more programs for running a chat service. The chat service operated by chat service module 110 is accessible by chat application 180 and enables users to receive machine-generated natural-language text replies to user-generated text prompts. Chat service module 110 runs services used and/or invoked by chat application 180 and, further, provides user-generated prompts to language module 112 and provides natural-language text replies generated by the program(s) of language module 112 to user device 170. Natural-language text replies generated by server 100 and transmitted to user device 170 in this manner can communicated to a user via chat application 180. For example, chat application 180 can cause output device 106 to display an indication, such as a text representation, of the natural-language text reply to allow a user (e.g., user 199) to read the reply and, in some examples, formulate a subsequent prompt.

While the service operated by chat service module 110 is generally referred to as a “chat service” herein, in some examples, the service operated by chat service 110 does not represent or relate user prompts and machine-generated replies as a natural-language text conversation. For example, the chat service operated by chat service module 110 can be an API for accessing functionality of language module 112, such that chat application 180 functions as an interface, program, etc. for accessing calling functions of the API.

General language generation module 120 is another software module of server 100 and includes one or more programs for automated natural-language text generation. General language generation module includes GPLM 122 and system prompt 124. GPLM 122 is a machine-learning language model trained to generate natural-language outputs (or tokenized representations thereof) from natural-language inputs (or tokenized representations thereof). GPLM 122 is not specialized and has not been fine-tuned to a particular workload and, consequently, is able to generate language in response to a wider variety of prompts than a model that has been trained or fine-tuned for a particular workload (e.g., SLMs 132A-N). In some examples, general language generation module 120 and/or GPLM 122 can include one or more programs for converting natural-language inputs into numeric representations and for converting numeric representations of text information into natural-language text. For example, general language generation module 120 and/or GPLM 122 can include a tokenization algorithm for generating tokens representative of text (e.g., encoding user inputs) and for generating natural-language text based on token information (e.g., decoding machine-generated tokens). GPLM 122 can be, for example, a large language model and/or a transformer model. In some examples, GPLM 122 can be referred to as a “primary general-purpose machine-learning language model.” Further, as used herein, “natural-language text” can include tokenized and other encoded representations of natural-language text.

System prompt 124 is natural-language text and/or a tokenized representation of natural-language text (i.e., one or more tokens representative of natural-language text) and provides instructions to language model 120 for generating natural-language responses to user-generated prompt text. System prompt 124 can be stored as, for example, a natural-language text string, an encoded text string (e.g., encoded as one or more tokens), or any other suitable format. System prompt 124 is generally referred to herein as a “system prompt,” but in other examples system prompt 124 can be referred to as a “pre-prompt” or “internal prompt.” Language module 112 includes one or more programs that provide system prompt 124 to language model 120 prior to providing user prompts. The process of providing system prompt 124 to language model 120 is generally referred to herein as “system prompting.”

Specialized language generation module 130 is another software module of server 100 and includes one or more programs for generating specialized language in response to user prompts based on natural language stored by vendor knowledge sources 190A-N. In particular, specialized language generation module 130 includes SLMs 132A-N, which are specialized machine-learning language models. Each of SLMs 132A-N is a general-purpose machine-learning language model that has been fine-tuned or trained to generate language using natural-language from a single vendor knowledge source 190A-N, such that each of SLMs 132A-N is able to generate vendor-specific language in response to user-provided technical questions or queries contained in a user-submitted prompt (i.e., submitted via chat application 180). Each of SLMs 132A-N can be used to generate language that is specific or specialized to a particular technical product vendor, a particular line or category of technical products, and/or one or more particular, individual technical products, among other options. FIG. 1 depicts three SLMs 132A-N for clarity and explanatory convenience, but in other examples server 100 and specialized language generation module 130 can include any suitable number of specialized machine-learning language models, including more than three specialized machine-learning language models. In at least some examples, server 100 and specialized language generation module 130 include fewer than three specialized machine-learning language models.

As SLMs 132A-N have been trained or fine-tuned using the natural-language technical information stored in vendor knowledge sources 190A-N, SLMs 132A-N are able to generate natural language that includes or is based on the technical knowledge stored in vendor knowledge sources 190A-N. The training or fine-tuning performed to generate SLMs 132A-N from one or more general-purpose language models allows prompts to SLMs 132A-N to generate language that recreates, summarizes, or otherwise reconstructs technical knowledge from vendor knowledge sources 190A-N in response to user prompts that include technical queries. Each of SLMs 132A-N, to this extent, functions as a resource for specialized technical knowledge and the outputs of SLMS 132A-N can, accordingly, be leveraged by GPLM 122 to more accurately answer user technical queries according to the multi-model polling described herein.

In some examples, specialized language generation module 120 and/or SLMs 132A-N can include one or more programs for converting natural-language inputs into numeric representations and for converting numeric representations of text information into natural-language text. For example, specialized language generation module 120 and/or one or more of SLMs 132A-N can include a tokenization algorithm for generating tokens representative of text (e.g., encoding user inputs) and for generating natural-language text based on token information (e.g., decoding machine-generated tokens). Each of SLMs 132A-N can be, for example, a large language model and/or a transformer model.

Further, each of SLMs 132A-N can include or use a system prompt that performs a substantially similar function as system prompt 124. However, the system prompt(s) used by SLMs 132A-N are generally static and are not changed during operation of server 100 by system prompt modification module 160. Conversely, as will be explained subsequently, system prompt 124 can be modified during operation of server 100 to alter the function performed by GPLM 122.

Polling module 140 is a software module of server 100 and includes one or more programs for providing user-generated prompts received by chat service module 110 to SLMs 132A-N and, in some examples, to GPLM 122. The process of providing a single user prompt to multiple machine-learning language models is referred to herein as “polling” the machine-learning language models and the outputs created by SLMs 132A-N and, in applicable examples, GPLM 122 are referred to herein as “polling outputs” or “polled natural-language outputs.”

Aggregation module 150 is a software module of server 100 and includes one or more programs for aggregating the outputs of machine-learning language models into a new, aggregated prompt suitable as an input for GPLM 122. Aggregation module 150 receives and aggregates the outputs of SLMs 132A-N generated in response to a user-provided prompt into a single text prompt suitable for use as an input to GPLM 122. In examples where polling module 140 also polls GPLM 122, aggregation module 150 can also include the output from GPLM 122 produced in response to the user prompt as part of the aggregated prompt. Aggregation module 150 can also provide the initial user prompt as part of the aggregated prompt. The output generated by GPLM 122 in response to the aggregated prompt created by aggregation module 150 is referred to herein as an “orchestrated output” or an “orchestrated natural-language output.”

In some examples, aggregation module 150 can provide a short description of the identity of the machine-learning language model that generated the output and contextually associate that description in the aggregated prompt with the output generated by that machine-learning language model. The description can be, for example, the vendor and/or product line described in the technical information used to generate the relevant SLM 132A-N. Where GPLM 122 also generates an output based on the initial user prompt and that output is included in the aggregated prompt generated by aggregation module 150, the description can identify GPLM 122 as a general-purpose language model.

System prompt modification module 160 is a software module of server 100 that includes one or more programs for modifying system prompt 124 used by GPLM 122. System prompt modification module 160 is an optional component of server 100 and is included in examples where GPLM 122 is polled by polling module 140. Prior to polling of GPLM 122 by polling module 140, system prompt modification module 160 modifies system prompt 124 to instruct GPLM 122 to generate a completion that answers the user's technical query. This initial system prompt 124 instructs or otherwise allows GPLM 122 to generate or attempt to generate language responsive to the user's prompt. Following polling of GPLM 122, system prompt modification module 160 then modifies system prompt 124 to instruct GPLM 122 to answer the user prompt (i.e., the same prompt used to poll GPLM 122 and SLMs 132A-N) by synthesizing information the polling outputs from GPLM 122 and SLMs 132A-N.

The second system prompt can instruct GPLM 122 to act as an orchestrator and, more specifically, to generate a response based only on information contained in an aggregate prompt received from aggregation module 150. The orchestrated output generated by GPLM 122 can then be provided to the user. In examples where GPLM 122 is not polled, system prompt 124 can be static and can always instruct GPLM to generate language based only on the content of the aggregate prompt, and system prompt modification module 160. The system prompt 124 used by GPLM 122 to generate the orchestrated output can, for example, instruct GPLM 122 to pick the polled response that is most responsive or most relevant to the user prompt. Additionally and/or alternatively, the system prompt 124 can permit GPLM 122 to synthesize language and information from two or more polled outputs to generate the orchestrated output. The aforementioned embodiments of the system prompt 124 used for orchestrated output generation are illustrative and non-limiting examples, and, in other examples, other suitable system prompt 124 information can be used to cause GPLM 122 to generate a suitable orchestrated output.

Advantageously, use of a system prompt that includes an instruction for GPLM 122 to act as an orchestrator and to only use information contained in the aggregate response to generate a natural-language output can reduce the likelihood that the final natural-language output provided to the user contains a fabrication or hallucination, advantageously improving user experience by increasing the accuracy of the natural-language outputs received by the user.

Chat application 180 is a software application of user device 170 for receiving user prompts, providing those prompts to server 100, receiving responses from server 100, and communicating those responses to the user (e.g., user 199). Chat application 180 can be, in some examples, a web browser for accessing a web application hosted by server 100 that uses the functionality of chat service module 110. Additionally and/or alternatively, chat application 180 can be a specialized software application for interacting with chat service module 110 of server 100. Chat application 180 can be selectively operated by user device 170. For example, a user can provide one or more inputs to user device 170 to cause user device 170 to begin operating chat application 180. A user can provide user prompts by, for example, typing a natural-language phrase or sentence using a keyboard or a similar input device.

In operation, chat application 180 receives a user prompt provided by a user via user interface 176 of user device 170. Chat application 180 provides the user prompt to chat service module 110 of server 100. Chat service module 110 provides the user prompt to polling module 140, which polls SLMs 132A-N and, in some examples, GPLM 122, which generate natural language based on the user prompt. Aggregation module 150 receives the outputs of SLMs 132A-N and, optionally, GPLM 122 (i.e., if GPLM 122 was polled by polling module 140) and aggregates those outputs as well as the original user prompt into an aggregated prompt. Aggregation module 150 provides the aggregated prompt to GPLM 122, which generates natural language responsive to the user's technical query. GPLM 122 leverages language and word associations represented by the parameters, hyperparameters, etc. of GPLM 122 to review the outputs of SLMs 132A-N, identify language that is responsive to the user's technical query, and incorporate that language into a natural-language text output suitable for communication to the user who submitted the query. Chat service module 110 then causes server 100 to transmit the orchestrated output from GPLM 122 (i.e., the output from the aggregated prompt) to user device 170, and chat application 180 causes user device 170 to communicate the orchestrated output to the user.

The user can then use the response from GPLM 122 to solve or attempt to solve the user's technical problem. For example, the user can perform one or more troubleshooting actions outlined in the automated response generated by the program(s) of server 100. If the first output does not solve the user's technical problem, the user can submit a new prompt including natural-language text indicating that the previous troubleshooting steps did not solve the user's technical problem. In some examples, server 100 can store a conversation history for the user and can reference the conversation history to improve language generation and reduce the need for the user to explain via natural-language text the previous troubleshooting steps recommended by server 100. Additionally and/or alternatively, if text generated in response to a user technical query does not solve the user's underlying technical problem, the user can shift to a human-mediated technical support session. The time required for human-mediated technical support to solve the user technical problem can be significantly reduced by the troubleshooting steps performed by the user in response to automated technical support messages generated by server 100 (e.g., by prompting a user to perform certain troubleshooting tasks prior to seeking out human-mediated technical support, etc.).

In examples where GPLM 122 is polled by polling module 140, system prompt modification module 160 modifies system prompt 124 prior to language generation based on the user prompt to instruct GPLM 122 to answer the user's query or otherwise generate a completion responsive to the user's prompt. System prompt modification module 160 then modifies system 124 again prior to language generation based on the aggregated prompt (i.e., generated by aggregation module 150) to instruct GPLM 122 to act as an orchestrator or coordinator and to answer the user's query based on the polling outputs.

Advantageously, the use of both specialized and general-purpose language models in the multi-model polling approach outlined herein allows each of SLMs 132A-N to optionally include fewer parameters, hyperparameters, etc. than GPLM 122. Notably, using SLMs 132A-N that have fewer parameters, hyperparameters, etc. as compared to GPLM 122 or another general-purpose language model reduces to hardware requirements and associated costs needed to generate language using SLMs 132A-N. Further, specialization of SLMs 132A-N on a per-vendor, per-product line, or per-product basis further reduces the number of parameters, hyperparameters, etc. required for SLMs 132A-N to accurately recreate, summarize, etc. technical information from vendor knowledge sources 190A-N in response to user prompts. Notably, multi-model polling of specialized language models provides improved response accuracy as compared to conventional context injection approaches (e.g., retrieval augmented generation).

Further, the multi-model polling approach enabled by server 100 of technical support system 10 allows for specialized language models to be used in language generation without requiring the use of an agent or another specialized program to identify and select an appropriate SLM 132A-N for language generation for a particular user query. Rather, GPLM 122 is instructed (i.e., via system prompt 124) to review the outputs of all SLMs 132A-N and is able to use the language associations encoded to the parameters, hyperparameters, etc. of GPLM 122 to review those outputs and generate language that is responsive the user prompt (e.g., by selecting a polled output, by synthesizing information, etc.). Notably, the use of GPLM 122 to generate the natural-language that is ultimately provided to the user allows the language generated by SLMs 132A-N to lack fluidity, prose, readability, etc., so long as those outputs are usable by GPLM 122 to generate a readable, coherent output to the user. In at least some examples, GPLM 122 is a Generative Pre-trained Transformer model (e.g., GPT-3.5 or GPT-4) and SLMs 132A-N are based on a Large Language Model Meta AI (LLaMA) model.

FIG. 1 depicts only one user device (i.e., user device 170) for illustrative convenience and for clarity, but in other examples, system 10 can include any number of user devices. System 10 can, for example, include multiple analogous user devices serving parallel functions, e.g., at different locations and/or for different users. Additionally or alternatively, functions of user device 170 (and any analogous user devices) can be distributed across multiple separate hardware devices accessible locally and/or via network 188. Similarly, while server 100 is depicted as a single device in FIG. 1, in other examples, server 100 can include multiple devices (e.g., multiple servers) configured to perform the functions of server 100. Further, while vendor knowledge sources 190A-N are depicted as separate devices in FIG. 1, two or more vendor knowledge sources 190A-N can be virtualized on a single electronic device or across multiple, distributed electronic devices.

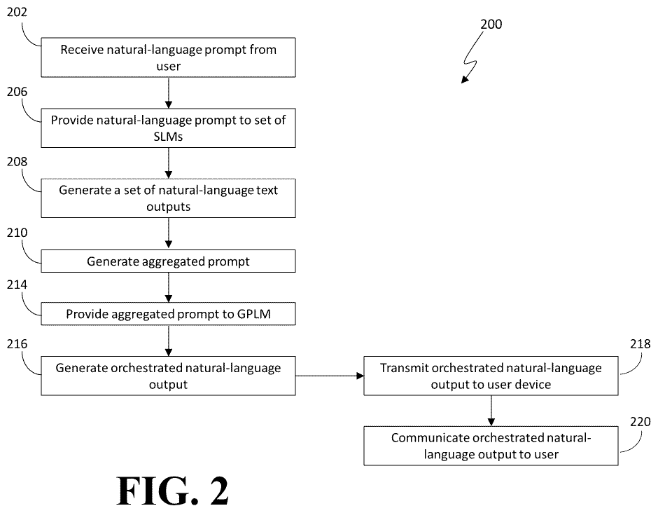

FIG. 2 is a flow diagram of method 200, which is a method of polling a set of language models to generate a natural-language response to a user technical question. FIG. 2 includes steps 202-218 of receiving a natural-language prompt from a user (step 202), providing the natural language prompt to a set of specialized machine-learning language models (step 206), generating an aggregated prompt (step 208), providing the aggregated prompt to a general-purpose language model (step 212), generating an orchestrated natural-language output (step 214), transmitting the orchestrated natural-language output to a user device (step 216), and communicating the orchestrated natural-language output to the user (step 218). Method 200 is discussed generally herein with respect to the devices of system 10, but method 200 can be performed using any suitable system to confer advantages of language model polling described herein.

In step 202, server 100 receives a user prompt from a user device (e.g., user device 170). A user can enter the prompt into a chat client configured to interact with and use functionality of server 100 (e.g., chat application 180). The prompt includes one or more technical queries related to a technical issue the user is experiences with one or more electronic devices. The affected device(s) can be the device operating the chat client and/or any other suitable electronic device. For example, if the technical issue relates to an improperly functioning or non-functioning electronic device, the user may operate a chat client from a different device than the affected device. The chat client can provide the prompt and an identifier for the user to server 100. User device 170 can transmit the user prompt to server 100 as, for example, one or more packets via network 188.

In some examples, the user can enter a message composed at least partially of the technical question into a chat application configured to interact with and use functionality of server 100 (e.g., chat application 180), and the chat application can provide the message to server 100 (i.e., by transmitting the message or an indication thereof to server 100). The received message can be used as the prompt received in step 202 and/or server 100 can remove portions of the user message, such as extraneous filler words, and use the resulting natural-language text as the prompt.

In step 206, polling module 140 provides the user prompt received in step 202 to SLMs 132A-N as an input prompt to each of SLMs 132A-N. Notably, each of SLMs 132A-N is provided with substantially the same or the same prompt in step 206.

In step 208, SLMs 132A-N generate a set of outputs based on the user prompt. Each of SLMs 132A-N is trained or fine-tuned with a vendor-, product line-, or product-specific dataset derived from a vendor knowledge source 190A-N and is able to generate language that recreates, summarizes, or otherwise reconstructs technical knowledge from the vendor knowledge sources 190A-N on which the SLM 132A-N was trained or fine-tuned. If a vendor knowledge source 190A-N includes text responsive to the user's technical query, it is likely that the output from the SLM 132A-N trained or fine-tuned using that vendor knowledge source 190A-N will also include text responsive to the user's technical query.

In step 210, aggregation module 150 generates an aggregated prompt. More specifically, aggregation module 150 aggregates the outputs generated in step 208 into a single, natural language prompt (or tokenized representation thereof) that can be used as an input to GPLM 122. The aggregated prompt can optionally include an additional representation (e.g., as text) of the user's initial prompt (i.e., the prompt received in step 202). As described previously within the discussion of FIG. 1, aggregation module 150 can provide a description of each SLM 132A-N contextually adjacent (e.g., as a heading or introductory sentence) to the output from the SLM 132A-N. The description can be, for example, a brief description of the vendor, product line, product, etc. described in the vendor knowledge source 190A-N on which the SLM 132A-N was trained or fine-tuned.

In step 214, aggregation module 150 provides the aggregated prompt as an input to GPLM 122. Prior to step 214, a user or system prompt modification module 160 modifies system prompt 124 to instruct GPLM 122 to act as an orchestrator so as to generate a response based only information contained in an aggregate prompt received from aggregation module 150. The orchestrated output generated by GPLM 122 can then be provided to the user. For example, the system prompt 124 can instruct GPLM 122 to pick the polled response contained within the aggregated prompt that is most responsive or most relevant to the user prompt. As an additional example, the system prompt 124 can permit GPLM 122 to synthesize language and information from two or more polled outputs to generate the orchestrated output.

In step 216, GPLM 122 generates an orchestrated natural-language output based on the aggregated prompt provided in step 214. The orchestrated natural-language output is responsive to the user's technical query contained in the prompt received in step 202.

In step 218, chat service module 110 transmits the output generated in step 216 or an indication thereof to user device 270. The output can be transmitted as, for example, one or more packets via network 188. Server 100 can be configured to automatically transmit the output to user device 170 after step 314.

In step 220, user device 170 communicates the output generated in step 216 to the user operating the user device. User device 170 can provide an indication of the output to the user, such as displayed text of the natural-language output, spoken audio of the natural-language output, etc.

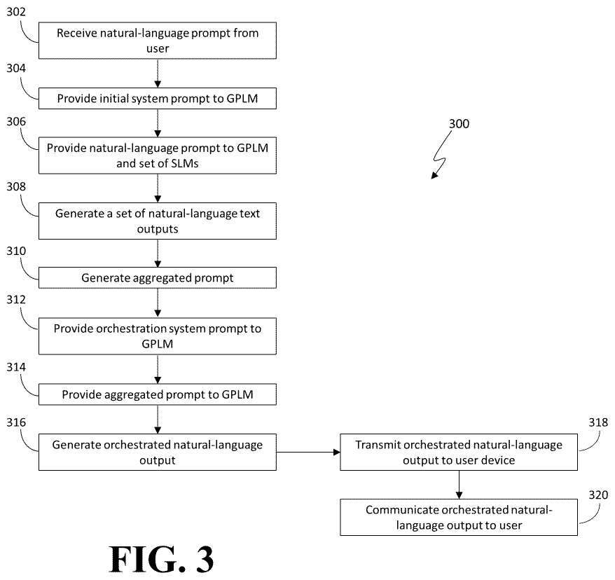

FIG. 3 is a flow diagram of method 300, which is another method of method of polling a set of language models to generate a natural-language response to a user technical question. Method 300 is substantially similar to method 200 (FIG. 2), but includes polling of GPLM 122 by polling module 140. Method 300 includes steps 302-320 of receiving a natural-language prompt from a user (step 302), providing an initial system prompt to a general-purpose machine-learning language model (step 304), providing the natural language prompt to the general-purpose machine-learning language model and a set of specialized machine-learning language models (step 306), generating an aggregated prompt (step 308), providing an orchestration system prompt to the general-purpose machine-learning language model (step 310), providing the aggregated prompt to the general-purpose language model (step 312), generating an orchestrated natural-language output (step 314), transmitting the orchestrated natural-language output to a user device (step 316), and communicating the orchestrated natural-language output to the user (step 318). Method 300 is discussed generally herein with respect to the devices of system 10, but method 300 can be performed using any suitable system to confer advantages of language model polling described herein.

In step 302, server 100 receives a natural-language prompt including a technical question. Step 302 can be performed in the same or in a substantially similar manner as step 202 of method 200 (FIG. 2), and the discussion of step 202 of method 200 is applicable to step 302 of method 300.

In step 304, an initial system prompt is provided to GPLM 122. System prompt modification module 160 modifies system prompt 124 with an initial system prompt that instructs GPLM 122 to generate a completion that answers or attempts to answer the user's technical question contained in the prompt received in step 302. System prompt 124 is then provided to GPLM 122 ahead of the natural-language prompt in subsequent step 306. Step 304 can be performed automatically by server 100 in response to receiving the natural-language prompt in step 302.

In step 306, the natural-language prompt received in step 302 is provided to GPLM 122 and SLMs 132A-N. More specifically, in step 306, polling module 140 polls both GPLM 122 and SLMs 132A-N. The models polled in step 306 can be polled in the same or a substantially similar manner as the polling described with respect to step 206 of method 200 (FIG. 2).

In step 308, a set of natural-language text outputs are generated by GPLM 122 and SLMs 132A-N based on the natural-language prompt provided in step 306. The polled models (i.e., GPLM 122 and SLMs 132A-N) can generate language in the same or substantially the same manner in step 308 as is described in the discussion of step 208 of method 200 (FIG. 2).

In step 310, an aggregated prompt is generated by aggregating the outputs generated in step 308 into a single, natural-language prompt (or tokenized representation thereof). The aggregated prompt generated in step 310 is generated using the outputs generated in step 308 in the same or substantially similar manner as the aggregated prompt is generated in step 210 of method 200 using the outputs generated in step 210 (FIG. 2), and the discussion of step 210 is application to step 310 of method 300. Notably, the aggregated prompt generated in step 310 includes outputs from both SLMs 132A-N and GPLM 122.

In step 312, GPLM 122 is provided with an orchestration system prompt. More specifically, system prompt modification module 160 modifies system prompt 124 with a second system prompt that instructs GPLM 122 to act as an orchestrator such that to generate a response based only information contained in an aggregate prompt received from aggregation module 150. The orchestrated output generated by GPLM 122 can then be provided to the user. For example, the system prompt 124 can instruct GPLM 122 to pick the polled response contained within the aggregated prompt that is most responsive or most relevant to the user prompt. As an additional example, the system prompt 124 can permit GPLM 122 to synthesize language and information from two or more polled outputs to generate the orchestrated output. The modified system prompt is provided to GPLM 122 ahead of the aggregated prompt in step 314. Step 312 can be performed substantially simultaneously as or subsequent to step 310 of method 300, but is performed prior to step 314.

In step 314, GPLM 122 is provided with the aggregated prompt generated in step 310. In step 316, GPLM 122 generates an orchestrated natural-language output based on the aggregated prompt provided in step 314. In step 318, the orchestrated natural-language output is transmitted to a user device and in step 320, the orchestrated natural-language output is communicated to the user who generated the prompt received in step 302. Steps 314, 316, 318, and 320 can be performed in the same or substantially the same manner as steps 214, 216, 218, and 220 of method 200 (FIG. 2), respectively, and the discussion of steps 214, 216, 218, and 220 of method 200 is applicable to steps 314, 316, 318, and 320 of method 300, respectively.

Steps 218-220 and step 318-320 of method 200 and method 300, respectively, are optional and can be performed where it is desirable to transmit the outputs generated in steps 216, 316, respectively, to the user and, further, to communicate those outputs to the user. Steps 218-220 and steps 318-320 can be performed at any suitable time after steps 216, 316, respectively, and, in at least some examples, are performed automatically by server 100 and substantially immediately after steps 216, 316, respectively, are performed.

The multi-model polling approach outlined in method 200 and method 300 advantageously improves the accuracy of automated technical support answers generated by general-purpose machine-learning language models by leveraging specialized knowledge encoded to SLMs 132A-N. As described previously, the use of both of both specialized and general-purpose language models allows each of SLMs 132A-N to optionally include fewer parameters, hyperparameters, etc. than GPLM 122, consequently reducing the hardware requirements (and costs associated with language generation) needed to poll SLMs 132A-N according to method 200 and method 300. Further, the multi-model polling approach enabled by server 100 of technical support system 10 does not require an agent or other specialized decision-making software to identify and select an appropriate SLM 132A-N for language generation for a particular user query. Rather, all available SLMs 132A-N are polled and GPLM 122 is leveraged to generate language that is appropriately responsive to the user prompt based on the outputs of SLMs 132A-N and, in method 300, an output from GPLM 122.

Notably, method 200 has lower computational costs than method 300 as method 200 does not poll GPLM 122, which, as described previously, can have a substantially larger quantity of parameters, hyperparameters, etc. than any of SLMs 132A-N. However, in some examples, it can be advantageous to leverage knowledge and language associations encoded to GPLM 122 in addition to the specialized knowledge of SLMs 132A-N. For example, including a polled output from GPLM 122 can increase the readability or another quality of the subsequent orchestrated output generated by GPLM 122. In these examples, it can be advantageous to perform method 300.

Method 200 and method 300 can be repeated for each user query or prompt submitted via a chat application configured to interface with chat service module 110 (e.g., chat application 180). Each subsequent user query or prompt can detail a new technical problem and/or can detail the same technical problem. For example, if an automated message generated using method 200 or method 300 is not able to sufficiently resolve a user's technical problem, the user can submit a subsequent message or prompt indicating that the previous message did not resolve the user's technical problem, and a subsequent iteration method 200 or method 300 can be performed to generate new natural-language text responsive to the user's technical problem as described in the user's most-recent prompt. In at least some examples,

In some examples, the outputs from method 200 and method 300 can mimic natural-language responses from another human and, in yet further examples, the chat application (e.g., chat application 180) can present the outputs of method 200 and method 300 (i.e., the outputs generated in step 216 and step 316, respectively) in a format that mimics text conversations with another human via a chat application. In at least some examples, the user's chat history (or a summarization thereof) can be included with the prompt received in step 202 to provide SLMs 132A-N and GPLM 122 with context regarding previously-recommended troubleshooting steps, technical advice, etc. generated using method 200 or method 300. Additionally and/or alternatively, if text generated in response to a user technical query does not solve the user's underlying technical problem, the user can shift to a human-mediated technical support session. As described previously, the troubleshooting steps, technical advice, etc. generated using method 200 and method 300 can significantly reduce the time required for subsequent human-mediated technical support.

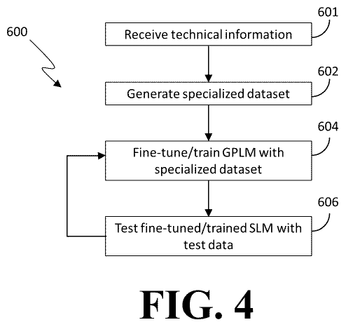

FIG. 4 is a flow diagram of method 600, which is a method of fine-tuning or training a general-purpose machine-learning language model to generate one of SLMs 132A-N (FIG. 1). Machine-learning language models trained according to method 600 are capable of accepting as natural-language text and/or representations thereof describing as inputs and generating outputs that recreate, summarizes, reconstructs, or otherwise includes technical knowledge stored in a vendor knowledge source 190A-N. Method 600 includes steps of 601-606 of receiving technical information (step 601), generating a specialized dataset (step 602), fine-tuning or training a general-purpose machine-learning language model with the specialized dataset (step 604), and testing the fine-tuned or trained specialized machine-learning language model with test data (step 606). Method 600 is described herein with respect to server 100 (FIG. 1), but method 600 can be performed by any suitable computing device and the models fine-tuned or trained using method 600 can be used by server 100 to perform method 200 and/or method 300 (FIGS. 2-3) as described herein.

In step 601, technical information is received by server 100. The technical information is received from a vendor knowledge source 190A-N by server 100. The technical information can be, for example, technical documents received from a vendor knowledge source 190A-N that describe technical products. The technical information can describe all technical products offered by a particular vendor, a particular line or category of technical products, and/or one or more particular, individual technical products. The technical information can be received by, for example, requesting (e.g., querying, searching, etc.) the technical information from a vendor knowledge source 190A-N. The received technical information can be all technical information stored to the vendor knowledge source 190A-N and/or any suitable subset of the stored technical information.

In step 602, a specialized dataset is generated based on the technical information received in step 601. The specialized dataset is labeled data derived from the technical information received in step 601 and is suitable for fine-tuning and/or training a general-purpose machine-learning language model in subsequent step 604. The specialized dataset can be generated by, for example, separating technical documents received in step 601 into discrete passages or sections that relate to separable technical problems, troubleshooting steps, product descriptions, etc. The separated passages can then be labeled to form the specialized dataset. The label for each passage can be, for example, a natural-language prompt (or text designed to mimic a natural-language prompt) generated by a human operator and related to the content of the separated passage, a description of a technical product described in the passage, a description of a technical solution (e.g., one or more troubleshooting steps) described in or related to the passage, or any other suitable description for fine-tuning or training a general-purpose machine-learning language model to generate language useful for solving user technical problems.

In step 604, the labeled data is used to fine-tune or train a general-purpose machine-learning language model to generate a specialized machine-learning language model. As used herein, “fine-tuning” a computer-implemented machine learning model refers to any process by which a subset (i.e., less than all) parameters, hyper parameters, biases, weights, and/or any other value related to model accuracy are adjusted to improve the fit of the computer-implemented machine learning model to the training data. As used herein, “training” a computer-implemented machine learning model refers to any process by which all or substantially all parameters, hyper parameters, biases, weights, and/or any other value related to model accuracy are adjusted to improve the fit of the computer-implemented machine learning model to the training data.

In step 606, the trained computer-implemented machine learning model is tested with test data. The test data used in step 506 is data specialized dataset used to train the computer-implemented machine-learning language model in step 604 and is used to qualify and/or quantify performance of the trained, specialized machine-learning language model. In some examples, the test data used in step 606 can be a subset of the specialized dataset generated in step 602 that is not used for training in step 604. A human or machine operator can evaluate the performance of the trained SLM by evaluating the fit of the model to the test data. An operator can evaluate the fit of the trained SLM by, for example, evaluating the relevance of outputs of the trained SLM to various prompts including sample technical questions. As depicted in FIG. 4, steps 604 and 606 can be performed iteratively to improve the performance of the machine learning model. More specifically, if the fit of the model determined in step 606 is undesirable (i.e., the fit of the model to the test data), step 604 can be repeated to further adjust the parameters, hyper parameters, biases, weights, etc. of the model to improve and adjust the fit of the model. Step 604 can be repeated using the same specialized dataset (or portion thereof) used in a previous iteration of step 604 or can be repeated using new training data of substantially the same kind as forms the specialized dataset. Step 606 can then be repeated with a new set of unlabeled test data or the same set of test data to determine how the adjusted model fits the new set of unlabeled test data. If the fit continues to be undesirable, further iterations of steps 604 and 606 can be performed until the fit of the model becomes desirable.

### Discussion of Possible Embodiments

The following are non-exclusive descriptions of possible embodiments of the present invention.

A method of automated technical support, the method comprising: receiving, by a server and from a user device, a natural-language text prompt provided by a user and including at least one technical query; providing a first system prompt to a primary general-purpose machine-learning language model, wherein the first system prompt instructs the primary general-purpose language model to generate an answer to user prompts; providing, after providing the first system prompt, the natural-language text prompt to the primary general-purpose machine-learning language model and each of a plurality of specialized machine-learning language models; generating, by the plurality of specialized machine-learning language models and the primary general-purpose machine-learning language model, a plurality of natural-language text outputs, one natural-language text output of the plurality of natural-language text outputs from the primary general-purpose machine-learning language model and a remainder of the plurality of natural-language text outputs from the plurality of specialized machine-learning language models; generating, by the server, an aggregated prompt by combining the plurality of natural-language text outputs; providing a second system prompt to the primary general-purpose machine-learning language model, wherein the second system prompt instructs the primary general-purpose machine-learning language model to generate an answer to user prompts based on machine-learning language model outputs; providing, after providing the second system prompt, the aggregated prompt to the primary general-purpose machine-learning language model; and generating, by the primary general-purpose machine-learning language model, an orchestrated natural-language text output based on the aggregated prompt, the orchestrated natural-language text output responsive to the at least one technical query.

The method of the preceding paragraph can optionally include, additionally and/or alternatively, any one or more of the following features, configurations and/or additional components:

A further embodiment of the foregoing method, wherein each specialized machine-learning language model of the plurality of specialized machine-learning language models is a general-purpose language model that is fine-tuned using a specialized dataset.

A further embodiment of the foregoing method, and further comprising generating the plurality of specialized machine-learning language models by, for each specialized machine-learning language model of the plurality of specialized machine-learning language model: receiving a plurality of technical documents describing technical subject-matter; creating a specialized dataset for the technical subject-matter based on the plurality of technical documents; and fine-tuning a general-purpose machine-learning language model using the specialized dataset by adjusting at least one parameter of the general-purpose machine-learning language model based on the specialized dataset, such that the specialized machine-learning model is configured to generate natural language responsive to technical questions for the technical subject-matter.

A further embodiment of the foregoing method, wherein, for each specialized machine-learning language model, creating the specialized dataset comprises labeling a plurality of passages from the subset of the plurality of technical documents to generate a plurality of labeled passages.

A further embodiment of the foregoing method, wherein, for each specialized machine-learning language model, fine-tuning the general-purpose machine-learning language model comprises adjusting the at least one parameter to cause the general-purpose machine-learning language model to associate labels of the labeled passages with natural-language text from the plurality of labeled passages.

A further embodiment of the foregoing method, wherein the labels of the labeled passages comprise natural-language prompts.

A further embodiment of the foregoing method, wherein, for each specialized machine-learning language model, the technical subject-matter comprises technical products from a vendor and the plurality of technical documents describe the technical products from the vendor, such that the plurality of specialized machine-learning language models are responsive to technical questions for a plurality of vendors and each specialized machine-learning language model is configured to generate natural language responsive to technical questions for one vendor of the plurality of vendors.

A further embodiment of the foregoing method, wherein the at least one technical query comprises at least one technical problem for a technical product described by at least one technical document of the plurality of technical documents.

A further embodiment of the foregoing method, wherein the natural-language prompt is provided by the user to a chat application operating on the user device.

A further embodiment of the foregoing method, and further comprising transmitting, as one or more electrical signals and over a network connecting the server to the user device, the orchestrated natural-language text output from the server to the user device.

A further embodiment of the foregoing method, and further comprising communicating, by the user device, the orchestrated natural-language text output to the user.

A further embodiment of the foregoing method, wherein communicating the orchestrated natural-language text output comprises displaying, by a user interface of the user device, a representation of the orchestrated natural-language text output.

A further embodiment of the foregoing method, wherein generating the aggregated prompt comprises combining the plurality of natural-language text outputs and the natural-language text prompt.

A further embodiment of the foregoing method, wherein the primary general-purpose machine-learning language model is configured to generate completions of input prompts.

A further embodiment of the foregoing method, wherein each specialized machine-learning language model of the plurality of specialized machine-learning language models is configured to plurality are configured to generate completions of input prompts.

A further embodiment of the foregoing method, wherein the second system prompt instructs the primary general-purpose machine-learning language model to expect inputs comprising outputs from the plurality of specialized machine-learning language models and to generate the orchestrated natural-language text output by completing the natural-language text prompt based at least in part on the plurality of natural language text outputs.

A system for automated technical support, the system comprising: a user device electronically-connected to a network; a server electronically-connected to the network, the server comprising: a processor; and at least one memory encoded with instructions that, when executed, cause the processor to: receive, from the user device, a natural-language text prompt provided by a user and including at least one technical query; provide a first system prompt to a primary general-purpose machine-learning language model, wherein the first system prompt instructs the primary general-purpose language model to generate an answer to user prompts; provide, after the first system prompt, the natural-language text prompt to the primary general-purpose machine-learning language model and each of a plurality of specialized machine-learning language models; generate, using the plurality of specialized machine-learning language models and the primary general-purpose machine-learning language model, a plurality of natural-language text outputs, one natural-language text output of the plurality of natural-language text outputs from the primary general-purpose machine-learning language model and a remainder of the plurality of natural-language text outputs from the plurality of specialized machine-learning language models; generate an aggregated prompt by combining the plurality of natural-language text outputs; provide a second system prompt to the primary general-purpose machine-learning language model, wherein the second system prompt instructs the primary general-purpose machine-learning language model to generate an answer to user prompts based on machine-learning language model outputs; provide, after the second system prompt, the aggregated prompt to the primary general-purpose machine-learning language model; and generate, by the primary general-purpose machine-learning language model, an orchestrated natural-language text output based on the aggregated prompt, the polled natural-language text output responsive to the at least one technical query.

The system of the preceding paragraph can optionally include, additionally and/or alternatively, any one or more of the following features, configurations and/or additional components:

A further embodiment of the foregoing system, wherein the instructions, when executed, further cause the processor to generate the plurality of specialized machine-learning language models by, for each specialized machine-learning language model of the plurality of specialized machine-learning language model: receiving a plurality of technical documents describing technical subject-matter; creating a specialized dataset for the technical subject-matter based on the plurality of technical documents; and fine-tuning a general-purpose machine-learning language model using the specialized dataset by adjusting at least one parameter of the general-purpose machine-learning language model based on the specialized dataset, such that the specialized machine-learning model is configured to generate natural language responsive to technical questions for the technical subject-matter.

A further embodiment of the foregoing system, wherein the instructions, when generated, cause the processor to generate the aggregated prompt by combining the plurality of natural-language text outputs and the natural-language text prompt.

A further embodiment of the foregoing system, wherein: the instructions, when executed, further cause the processor to transmit, as one or more electrical signals and over a network connecting the server to the user device, the orchestrated natural-language text output from the server to the user device, and the user device is configured to communicate the orchestrated natural-language output to the user.

### Summation

Any relative terms or terms of degree used herein, such as “substantially”, “essentially”, “generally”, “approximately” and the like, should be interpreted in accordance with and subject to any applicable definitions or limits expressly stated herein. In all instances, any relative terms or terms of degree used herein should be interpreted to broadly encompass any relevant disclosed embodiments as well as such ranges or variations as would be understood by a person of ordinary skill in the art in view of the entirety of the present disclosure, such as to encompass ordinary manufacturing tolerance variations, incidental alignment variations, alignment or shape variations induced by thermal, rotational or vibrational operational conditions, and the like.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of automated technical support, the method comprising:
receiving, by a server and from a user device, a natural-language text prompt provided by a user and including at least one technical query;
providing a first system prompt to a primary general-purpose machine-learning language model, wherein the first system prompt instructs the primary general-purpose language model to generate an answer to user prompts;
providing, after providing the first system prompt, the natural-language text prompt to the primary general-purpose machine-learning language model and each of a plurality of specialized machine-learning language models;
generating, by the plurality of specialized machine-learning language models and the primary general-purpose machine-learning language model, a plurality of natural-language text outputs, one natural-language text output of the plurality of natural-language text outputs from the primary general-purpose machine-learning language model and a remainder of the plurality of natural-language text outputs from the plurality of specialized machine-learning language models;
generating, by the server, an aggregated prompt by combining the plurality of natural-language text outputs;
providing a second system prompt to the primary general-purpose machine-learning language model, wherein the second system prompt instructs the primary general-purpose machine-learning language model to generate an answer to user prompts based on machine-learning language model outputs;
providing, after providing the second system prompt, the aggregated prompt to the primary general-purpose machine-learning language model; and
generating, by the primary general-purpose machine-learning language model, an orchestrated natural-language text output based on the aggregated prompt, the orchestrated natural-language text output responsive to the at least one technical query.

2. The method of claim 1, wherein each specialized machine-learning language model of the plurality of specialized machine-learning language models is a general-purpose language model that is fine-tuned using a specialized dataset.

3. The method of claim 1, and further comprising generating the plurality of specialized machine-learning language models by, for each specialized machine-learning language model of the plurality of specialized machine-learning language model:
receiving a plurality of technical documents describing technical subject-matter;
creating a specialized dataset for the technical subject-matter based on the plurality of technical documents; and
fine-tuning a general-purpose machine-learning language model using the specialized dataset by adjusting at least one parameter of the general-purpose machine-learning language model based on the specialized dataset, such that the specialized machine-learning model is configured to generate natural language responsive to technical questions for the technical subject-matter.

4. The method of claim 3, wherein, for each specialized machine-learning language model, creating the specialized dataset comprises labeling a plurality of passages from the subset of the plurality of technical documents to generate a plurality of labeled passages.

5. The method of claim 4, wherein, for each specialized machine-learning language model, fine-tuning the general-purpose machine-learning language model comprises adjusting the at least one parameter to cause the general-purpose machine-learning language model to associate labels of the labeled passages with natural-language text from the plurality of labeled passages.

6. The method of claim 5, wherein the labels of the labeled passages comprise natural-language prompts.

7. The method of claim 5, wherein, for each specialized machine-learning language model, the technical subject-matter comprises technical products from a vendor and the plurality of technical documents describe the technical products from the vendor, such that the plurality of specialized machine-learning language models are responsive to technical questions for a plurality of vendors and each specialized machine-learning language model is configured to generate natural language responsive to technical questions for one vendor of the plurality of vendors.

8. The method of claim 7, wherein the at least one technical query comprises at least one technical problem for a technical product described by at least one technical document of the plurality of technical documents.

9. The method of claim 8, wherein the natural-language prompt is provided by the user to a chat application operating on the user device.

10. The method of claim 9, and further comprising transmitting, as one or more electrical signals and over a network connecting the server to the user device, the orchestrated natural-language text output from the server to the user device.

11. The method of claim 10, and further comprising communicating, by the user device, the orchestrated natural-language text output to the user.

12. The method of claim 11, wherein communicating the orchestrated natural-language text output comprises displaying, by a user interface of the user device, a representation of the orchestrated natural-language text output.

13. The method of claim 12, wherein generating the aggregated prompt comprises combining the plurality of natural-language text outputs and the natural-language text prompt.

14. The method of claim 13, wherein the primary general-purpose machine-learning language model is configured to generate completions of input prompts.

15. The method of claim 14, wherein each specialized machine-learning language model of the plurality of specialized machine-learning language models is configured to plurality are configured to generate completions of input prompts.

16. The method of claim 15, wherein the second system prompt instructs the primary general-purpose machine-learning language model to expect inputs comprising outputs from the plurality of specialized machine-learning language models and to generate the orchestrated natural-language text output by completing the natural-language text prompt based at least in part on the plurality of natural language text outputs.

17. A system for automated technical support, the system comprising:
a user device electronically-connected to a network;
a server electronically-connected to the network, the server comprising:
a processor; and
at least one memory encoded with instructions that, when executed, cause the processor to:
receive, from the user device, a natural-language text prompt provided by a user and including at least one technical query;
provide a first system prompt to a primary general-purpose machine-learning language model, wherein the first system prompt instructs the primary general-purpose language model to generate an answer to user prompts;
provide, after the first system prompt, the natural-language text prompt to the primary general-purpose machine-learning language model and each of a plurality of specialized machine-learning language models;
generate, using the plurality of specialized machine-learning language models and the primary general-purpose machine-learning language model, a plurality of natural-language text outputs, one natural-language text output of the plurality of natural-language text outputs from the primary general-purpose machine-learning language model and a remainder of the plurality of natural-language text outputs from the plurality of specialized machine-learning language models;
generate an aggregated prompt by combining the plurality of natural-language text outputs;
provide a second system prompt to the primary general-purpose machine-learning language model, wherein the second system prompt instructs the primary general-purpose machine-learning language model to generate an answer to user prompts based on machine-learning language model outputs;
provide, after the second system prompt, the aggregated prompt to the primary general-purpose machine-learning language model; and
generate, by the primary general-purpose machine-learning language model, an orchestrated natural-language text output based on the aggregated prompt, the polled natural-language text output responsive to the at least one technical query.

18. The method of claim 17, wherein the instructions, when executed, further cause the processor to generate the plurality of specialized machine-learning language models by, for each specialized machine-learning language model of the plurality of specialized machine-learning language model:
receiving a plurality of technical documents describing technical subject-matter;
creating a specialized dataset for the technical subject-matter based on the plurality of technical documents; and
fine-tuning a general-purpose machine-learning language model using the specialized dataset by adjusting at least one parameter of the general-purpose machine-learning language model based on the specialized dataset, such that the specialized machine-learning model is configured to generate natural language responsive to technical questions for the technical subject-matter.

19. The system of claim 18, wherein the instructions, when generated, cause the processor to generate the aggregated prompt by combining the plurality of natural-language text outputs and the natural-language text prompt.

20. The system of claim 19, wherein:
the instructions, when executed, further cause the processor to transmit, as one or more electrical signals and over a network connecting the server to the user device, the orchestrated natural-language text output from the server to the user device, and
the user device is configured to communicate the orchestrated natural-language output to the user.
